(19) United States
(12) Patent Application Publication
(10) Pub. No.: US 2020/0289245 A1
(43) Pub. Date: Sep. 17, 2020

(54) Dental Plaque Cleanser

(71) Applicants: Winston Zhang, Irvine, CA (US); Grace Yu. Zhang, Irvine, CA (US)

(72) Inventors: Winston Zhang, Irvine, CA (US); Grace Yu. Zhang, Irvine, CA (US)

(21) Appl. No.: 16/880,137

(22) Filed: May 21, 2020

(51) Int. Cl. A61C 17/20; A61C 1/00

(52) U.S. Cl. CPC A61C 17/20; A61C 1/0092; A61C 1/0015

(57) ABSTRACT

A dental plaque cleanser is a dental clinic device for cleansing dental supragingival and subgingival plaque biofilm as well as scaling calculus. The dental plaque cleanser comprises a water jet biofilm cleansing unit and an ultrasonic scaling unit.

### FIELD OF INVENTION

The field of the invention is a dental clinic device which is for cleansing dental supragingival and subgingival plaque biofilm as well as scaling calculus.

### BACKGROUND OF THE INVENTION

Dental plaque biofilm is one of the major causes for dental decay and gum disease. Worldwide, 60-90% of school children and nearly 100% of adults have dental decay reported by WHO. Half of America adults have periodontal disease reported by CDC.

Dental professionals recommend people to visit dental clinic twice a year for teeth cleaning and use scaling device such as ultrasonic scaler for the teeth cleaning. The ultrasonic scalers are often limited to the supragingival not the subgingival area and using a vibrating metal tip to tapping harden calculus but are incapable to cleanse sticky colorless plaque biofilm therein.

The ultrasonic scalers are unable to cleanse the unattached subgingival plaque biofilm which are dominant bacteria caused periodontitis and other diseases. The ultrasonic scalers are also unable to cleanse plaque at tooth extraction site that possible cause cancer.

The calculus is mineralized, none bio-active “dead” plaque. Therefore, the ultrasonic scaler is not effective for cleanse bio-active Dental plaque biofilm.

A study by the Biofilm Center of the University of South California finds dental water jet removes 99.9 percent of dental plaque biofilm. Dental water jet hygiene devices have been introduced: an oral hygiene apparatus U.S. Pat. No. 10,064,710, and a compact oral hygiene device U.S. Pat. No. 10,405,954. These oral hygiene devices cleanse sticky colorless supragingival plaque biofilm on tooth surface, the subgingival plaque biofilm in the periodontal pocket and suck out the subgingival plaque biofilm therein. But they have difficulty to remove harden calculus. Both of the mentioned innovations are for families not for dental professionals.

The present invention satisfies the shortcomings, limitations or disadvantages of dental clinic devices for the cleansing subgingival and supragingival plaque in the market and patent proposals in the prior art.

### CROSS REFERENCE

### U.S. Patent Documents

| | | |
|---|---|---|
| 9,463,077 | October 2016 | Zolhayat |
| 6,619,957 | September 2003 | Mosch et al. |
| 10,405,954 | September 2019 | Zhang et al. |
| 10,064,710 | September 2018 | Zhang et al. |

### SUMMARY OF THE INVENTION

The present invention, dental plaque cleanser, is a dental clinic device for completely cleanse supragingival and subgingival plaque biofilm as well as scaling calculus. The dental plaque cleanser comprises a water jet biofilm cleansing unit, ultrasonic scaling unit and a power supply.

The ultrasonic scaling unit comprises a controller circuit, a water/air supply, an oscillator, a transducer, a handpiece with tips and foot controller. The ultrasonic scaling unit is for scaling calculus. The ultrasonic scaling unit is activated by pushing on the foot controller. The said oscillator generates electrical energy including a current, a voltage and frequencies; the said transducer with handpiece converts electrical energy and actuates mechanical vibration on a water cooled tip; and the vibrated tip taps the calculus on the tooth.

The water jet biofilm cleansing unit comprises a controller circuit, a water supply, a motor, a coherent pump, a handle with tips. The water jet biofilm cleansing unit cleans supragingival and subgingival plaque biofilm. The coherent pump is a unique for the dental plaque cleanser. I named it a “coherent” pump; it is a specially designed as a constant-flow pump.

The coherent pump comprises three diaphragm chambers, each diaphragm chamber has an inlet and an outlet with the pressures of the diaphragm chambers to open and close. The coherent pump further comprises a lever having triple arms with each arm mounted at the three diaphragm chambers respectively. The coherent pump further comprises a buffer room with an outlet of the pump. Three outlets of the diaphragm chambers can fluidly connect to the buffer room. A center pole of the lever eccentrically inserts into a rotating arm of the motor. The lever is not rotating during the motor running but said triple arms asynchronously vibrating. Said arms vibrate changes the volume and pressure of corresponding diaphragm chamber. When an arm pushes and shrinking the diaphragm chamber, the water in the diaphragm chamber is propelled out to the buffer room. When an arm pulls the diaphragm chamber goes back to the original shape the water is drawn from the water supply to the diaphragm chamber. Said triple arms are asynchronously vibrated with corresponding diaphragm chambers propel water out to the buffer room and draw water into the diaphragm chambers. The coherent pump propels a pressured constant-flow out, at very low noise and very high energy efficacy.

Plurality of exchangeable tips could utilize constant water jet to blasting, penetrating and cleansing biofilms. A Swirl jet tip is a unique and having multifunction. The Swirl jet tip has a twist head. The twist head comprises a pipe with male external thread, a cap with a female internal thread and a pinhole centrally located at the top of the cap. The twist head further comprises a mechanism which divides a single flow into two separated flows, then alters flows directions and twists them. When the cap is screwed tightly against the pipe, twisted two flows eject out from said pinhole form a swirl hollow cone shaped that could open user's periodontal pocket to wash out plaque therein, meanwhile the high speed rotating water generates a low pressure zone like an aspirator to suck out the plaques in the bottom of user's periodontal pocket; when the cap is screwed slight loosely against the pipe, twisted two flows eject out from the said pinhole form a swirl stream shaped that cleanses a user's tooth extraction site; when the cap is screwed more loosely against the pipe, twisted two flows eject out from the said pinhole form a swirl drilling shaped that cleanses a spot such as a white spot.

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWINGS

FIG. 1 is a block diagram of a dental plaque cleanser.

FIG. 2 is a block diagram of an ultrasonic scaling unit.

FIG. 3 is a block diagram of a water jet biofilm cleansing unit.

FIG. 4 is a schematic view of the coherent pump.

FIG. 5 is a schematic view of the disassembled coherent pump.

FIG. 6 is a cross-sectional view showing the water flow of the coherent pump.

FIG. 7 is a schematic showing a Swirl Jet tip.

FIG. 8 is a schematic showing a twist head section of the Swirl Jet tip.

FIG. 9 is a schematic showing a cap is screwed tightly of the Swirl Jet tip.

FIG. 10 is a schematic showing a cap is screwed slight loosely of the Swirl Jet tip.

FIG. 11 is a schematic showing a cap is screwed more loosely of the Swirl Jet tip.

### DESCRIPTION OF THE PREFERRED EMBODIMENTS

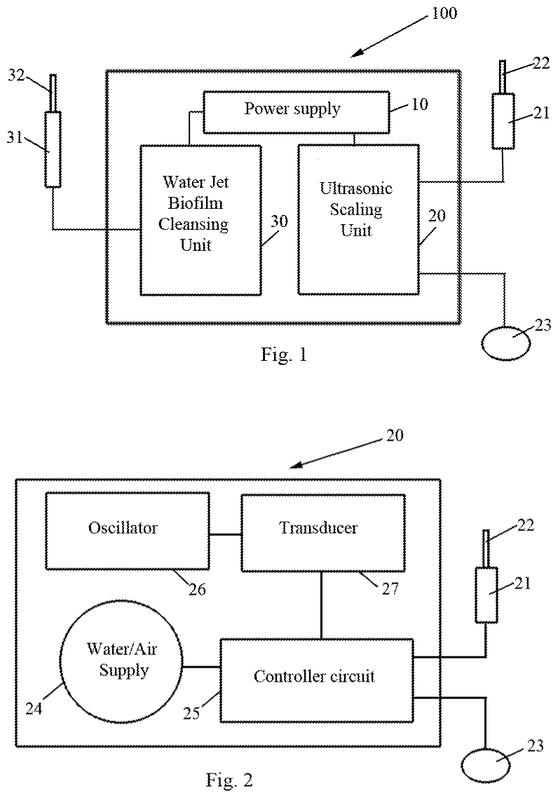

With reference to FIG. 1, an embodiment of a Dental plaque cleanser 100 generally comprises an ultrasonic scaling unit 20, a water jet biofilm cleanser unit 30 and power supply 10.

With reference to FIG. 2, the ultrasonic scaling unit 20 comprises a water/air supply 24, a controller circuit 25, an oscillator 26, a transducer 27, a handpiece 21, tips 22 and foot controller 23.

The ultrasonic scaling unit 20 is activated by pushing on the foot controller 23. The said oscillator 26 generates electrical energy including a current, a voltage and frequencies; the said transducer 27 with said handpiece 21 convert the electrical energy and actuate mechanical vibration on a water cooled said tip 22; and the vibrated tip 22 taps the calculus on a tooth.

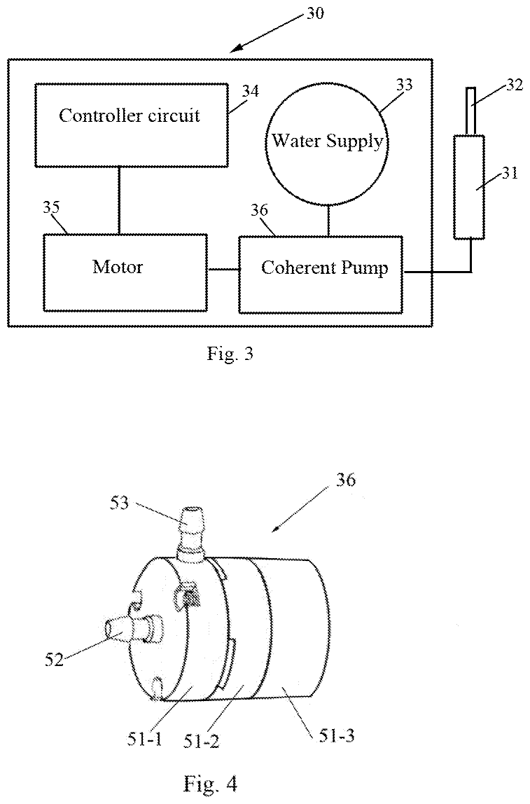

With reference to FIG. 3, the water jet biofilm cleanser unit 30 comprises a water supply 33, a controller circuit 34, a motor 35, a coherent pump 36, handle 31 and tips 32.

With reference to FIG. 4, an embodiment of the coherent pump 36 comprises an inlet/outlet section 51-1. The section 51-1 comprises a pump inlet 53, a pump outlet 52 and a buffer room is inside of the section 51-1. The coherent pump 36 further comprises a chambers section 51-2 and motor driven section 51-3.

With reference to FIG. 5, a coherent pump 36 comprises three diaphragm chambers 55-1, 55-2 and 55-3 in said section 51-2. Said coherent pump 36 further comprises a lever with triple arms 54-1, 54-2 and 54-3 correspondingly mounted at the bottoms of said three chambers 55-1, 55-2 and 55-3. Each diaphragm chamber has an inlet and an outlet. The FIG. 5 shows the chambers 55-1 has an inlet 56-1 and an outlet 57-1. The FIG. 5 also shows the chambers 55-2 has an inlet 56-2 and an outlet 57-2. The lever's center pole 58 eccentrically inserts into a motor's rotating arm.

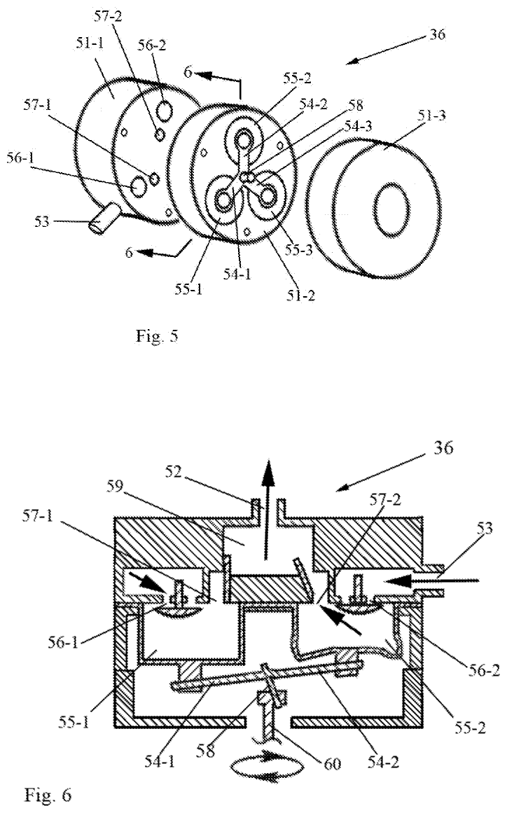

With reference to FIG. 6, a cross-sectional view shows the water flows inside the coherent pump. When the lever arm 54-1 goes down and the chamber 55-1 goes back to its original shape and draws water from inlet 53 though the inlet 56-1 into chamber 55-1. Meanwhile, the lever arm 54-2 goes up and the chamber 55-2 shrink with pressure increases and the water in the chamber 55-2 is propelled out through the outlet 57-2 to the buffer room 59. Said coherent pump draws water in from the inlet 53 by the three diaphragm chambers 55-1, 55-1 and 55-3 take turns unremittingly and the water is propelled out at the outlet 52 is a pressured constant-flow.

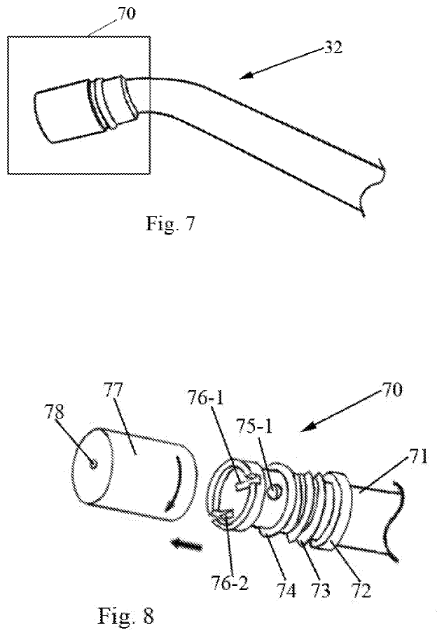

Plurality of exchangeable tips could utilize constant water jet to blasting, penetrating and cleansing biofilms. An embodiment of Swirl jet tip 32 with references to FIG. 7 and FIG. 8, the Swirl jet tip 32 comprises a twist head 70. The twist head 70 comprises a pipe 71 with a close off end, two holes 75-1 and 75-2 opposites each other on the wall of pipe 71, the hole 75-1 is show in the FIG. 8 but another hole 75-2 at the hidden side of pipe 71 and could not show; the twist head 70 further comprises two opposite parallel slopes 76-1 and 76-2 at the close off end of said pipe 71; The twist head 70 further comprises a ring gasket 74, an external thread 73 and a flange 72; The twist head 70 further comprises a cap 77 with internal thread that matches external thread 73 in the pipe 71, and a pinhole 78 centrally located at the top of the cap 77.

When water flows into said twist head 70 and then flows out from said two holes 75-1 and 75-2 become two flows. The cap 77 is screwed onto the pipe 71, the two water flows are blocked by the cap 77 and ring gasket 74 then two separated flows will go to the two slops 76-1 and 76-2 to twist. And

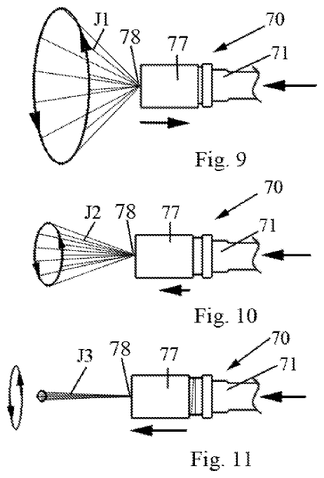

With reference to FIG. 9, when the cap 77 is screwed tightly against the pipe 71, twisted two flows eject out from the pinhole 78 form a swirl hollow cone shaped J1 that opens a user's periodontal pocket to wash out plaque therein. The rotating water of swirl hollow cone shaped J1 generates a low pressure zone and suck out plaque in deep of user's periodontal pocket.

With reference to FIG. 10, when the cap 77 is screwed slight loosely against the pipe 71, twisted two flows eject out from the pinhole 78 form a swirl stream shaped J2 that cleanses a user's tooth extraction site;

With reference to FIG. 11, when the cap 77 is screwed more loosely against the pipe 71, twisted two flows eject out from the said pinhole 78 form a swirl drilling shaped J3 that cleanses a spot such as a white spot.

The water jet biofilm cleansing unit 30 cleans dental supragingival and subgingival plaque biofilm.

Thus, specific embodiments and applications of a dental plaque cleaner have been disclosed. It should be apparent, however, to those skilled in the art that many more modifications beside those already described are possible without departing from the inventive concepts herein. The inventive subject matter, therefore, is not to be restricted except in the spirit of the appended claims. Moreover, in interpreting both the specification and the claims, all terms should be interpreted in the broadest manner possible consistent with the context, In particular, the terms “comprises” and “comprising” should be interpreted as referring to elements, components, or steps in a non-exclusive manner, indicating that the referenced elements, components, or steps may be present or utilized, or combined with other elements, components or steps that are not expressly referenced.

What is claim is:

1. A dental plaque cleanser is a dental clinic device for cleansing dental supragingival and subgingival plaque biofilm as well as scaling calculus; the dental plaque cleanser comprises a water jet biofilm cleansing unit and ultrasonic scaling unit.

2. The dental plaque cleanser of claim 1, the ultrasonic scaling unit comprises a controller circuit, a water/air supply, an oscillator, a transducer, a handpiece with tips and a foot controller; the ultrasonic scaling unit is activated by pushing on the foot controller and a water cooled tip vibrates to tap the calculus.

3. The dental plaque cleanser of claim 1, the water jet biofilm cleansing unit comprises a controller circuit, a water supply, a motor, a coherent pump, a handle and tips; the water jet biofilm cleansing unit cleanses dental supragingival and subgingival plaque biofilm.

4. The dental plaque cleanser of claim 3, wherein said coherent pump comprises three diaphragm chambers and each of them has an inlet and an outlet; and a buffer room has an outlet and can fluidly connect to the outlets of said three diaphragm chambers; said coherent pump further comprises a lever having triple arms with each arm mounted at said three diaphragm chambers respectively; said lever is not rotating during the driving motor running, but said triple arms are asynchronously vibrating; when an arm pushes and shrinking the diaphragm chamber, the water in the diaphragm chamber is propelled out to said buffer room; when an arm pulls the diaphragm chamber goes back to the original shape the water is drawn from the water supply to the diaphragm chamber; circulation of water is repeated during the motor running; and said coherent pump propels out a pressured constant pulseless water from said buffer room.

5. The dental plaque cleanser of claim 3, one of the tips is Swirl jet tip which having a twist head; wherein said twist head comprises a pipe with a male external thread, a cap with a female internal thread and a pinhole centrally located at the top of the cap and a mechanism that divides a single flow into two separated flows then twist said two flows; and
wherein when said cap is screwed tightly against said pipe, twisted two flows eject out from said pinhole form a swirl hollow cone shaped that opens a user's periodontal pocket to wash out plaque therein and to suck out plaque therein; when said cap is screwed slight loosely against said pipe, twisted two flows eject out from said pinhole form a swirl stream shaped that cleanses a user's tooth extraction site; when the cap is screwed more loosely against said pipe, twisted two flows eject out from the said pinhole form a swirl drilling shaped that cleanses a spot such as a white spot.
